(19) United States
(12) Patent Application Publication
(10) Pub. No.: US 2022/0287235 A1
(43) Pub. Date: Sep. 15, 2022

(54) Trimmer Attachment for Lawnmower

(71) Applicant: Donna Taylor, Deptford, NJ (US)

(72) Inventor: Donna Taylor, Deptford, NJ (US)

(21) Appl. No.: 17/692,097

(22) Filed: Mar. 10, 2022

Related U.S. Application Data
(60) Provisional application No. 63/159,134, filed on Mar. 10, 2021.

(51) Int. Cl. A01D 34/84; A01D 34/416; A01D 34/64; A01D 34/68; A01D 34/74; A01D 34/82

(52) U.S. Cl. CPC A01D 34/84; A01D 34/416; A01D 34/64; A01D 34/68; A01D 34/74; A01D 34/82; A01D 2101/00

(57) ABSTRACT

The present invention relates to a string or blade trimmer extension that can be integrated or retrofitted to a push lawnmower or riding lawnmower. The trimmer extension is attached to the inside deck of the lawnmower or to the frame and includes a linear track having channels allowing the trimmer head to extend outward from the deck and retract back into the deck. The trimming head has blades, or trimming lines, that are selectively operated by a user using the control handle and control button disposed on the lawnmower. The speed of rotation and angle of rotation can be adjusted using the control button while the height of the extension device can also be adjusted. The extension device allows a user to perform mowing and trimming weeds in different modes of operation.

### CROSS-REFERENCE TO RELATED APPLICATION

The present application claims priority to, and the benefit of, U.S. Provisional Application No. 63/159,134, which was filed on Mar. 10, 2021, and is incorporated herein by reference in its entirety.

### FIELD OF THE INVENTION

The present invention relates generally to lawn and garden equipment and related accessories. More specifically, the present invention relates to a string or blade trimmer extension that can be integrated or retrofitted to any type of push or riding lawnmower. The extension device allows the lawnmower to simultaneously perform mowing and trimming of weeds or other overgrown areas without requiring a separate trimming device. The invention reduces time for separately performing trimming and eliminates the need for a user to carry a heavy conventional string or blade trimmer. Accordingly, the present disclosure makes specific reference thereto. Nonetheless, it is to be appreciated that aspects of the present invention are also equally applicable to other like applications, devices and methods of manufacture.

### BACKGROUND

By way of background, a weed whacker, or string trimmer, is a common lawn and garden care tool for cutting grass, small weeds, overgrown areas and groundcover. A conventional portable string or blade trimmer has a long shaft with a handle at one end and an engine or power supply at the other end. A nylon string, plastic cord or plastic blade is housed in a trimmer head and the string or blade moves swiftly to cut unwanted grass, overgrown areas and weeds to achieve a well-manicured ornamental garden or lawn. Conventionally, a small gasoline or electric engine spins a rotor of the trimmer for providing power to the trimmer head to rotate and spin the blades or string. Both gas and electric trimmers are typically heavy, requiring energy of an individual to handle the trimmer during use. A person needs to manually carry a trimmer for manicuring gardens, lawns as well as overgrown areas such as fields, forests or other property. This can be difficult for people, especially older people and people with limited physical strength, to handle the trimmer for use.

Generally, people mow their lawns and gardens using a lawnmower, either a riding mower or a push mower, which is a time-consuming process. Therefore, trimming around gardens, fence areas, and other border areas of the property can be incredibly aggravating after spending time mowing a lawn. Often, people do not perform the trimming after mowing due to the time consumption and difficult handling of the trimmer device. People need to buy and maintain separate devices for mowing and trimming which is not only costly but requires more space for storage as well as spare parts for each. People desire a lawnmower that can perform both mowing and trimming during a single operation. Also, people desire a string or blade keeper attachment that can integrated or removably attached to a lawnmower.

Therefore, there exists a long-felt need in the art for a lawnmower attachment that has an integrated string or blade trimmer. There is also a long-felt need in the art for a string or blade trimmer attachment that can be connected to a riding or push lawnmower. Additionally, there is a long-felt need in the art for an improved string or blade trimmer that does not require a user to carry and handle the trimmer during use. Moreover, there is a long-felt need in the art for a lawnmower that can perform mowing and trimming simultaneously. Further, there is a long-felt need in the art for a string or blade trimmer that can be integrated or removably attached to a lawnmower. Furthermore, there is a long-felt need in the art for a string or blade trimmer extension that reduces the time and effort of a user to perform trimming. Finally, there is a long-felt need in the art for an improved lawn and garden care tool that offers a way to simultaneously mow a lawn and trim weeds without having to use an independent string or blade trimmer.

The subject matter disclosed and claimed herein, in one embodiment thereof, comprises a string or blade trimmer extension accessory configured to be integrated or retrofitted to the deck of a push or riding lawnmower. The device further includes a generally linear track that can be extended outward from the deck of the lawnmower and along different positions along the length of the track. A trimming header is fastened to a trailing end of the track. The trimming head includes plastic blades or string which is attached to a spool, and the spool is coupled to a rotor for rotation about a central axis. A pair of channels are disposed on side surfaces of the track allowing the track to extend or retract from the deck, or be positioned at different spots along the length of the track. A circuit for coupling the rotor to engine of the lawnmower for receiving power for rotation. The trimming lines or blades rotate at a rotational speed of between 5,500-7,000 rpm with about 6,000 to 6,500 rpms being preferred for cutting grass, weeds and other overgrown areas.

In this manner, the extension accessory and a lawnmower equipped with the extension of the present invention accomplishes all of the forgoing objectives and provides users with a string or blade trimmer extension equipped on a push or riding lawnmower. The invention easily attaches as a manufactured or retrofitted part to the mower deck and enables the user to extend the trimmer along the track, in a number of different positions, and lock it in place to operate at a single speed to cut weeds and other debris. The device offers a way to simultaneously mow a lawn and trim weeds and other overgrown areas without having to use an independent string or blade trimmer.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a string or blade trimmer extension accessory. The extension accessory is configured to be integrated or retrofitted to a deck of a lawnmower. The invention further includes a track that can be extended from the deck of the lawnmower, and a trimming head positioned in one or more slots in the track or alternatively, fixed in the end of the slot. The trimming header includes nylon trimming lines wrapped around a spool, or plastic or nylon blades connected to a central hub. The spool or head is coupled to a rotor, or central shaft, for rotation; a pair of channels disposed along the side surfaces of the track allows the track to extend or retract from the deck or be positioned at different spots, so that the track may be fully extended or partially extending one or more settings. A circuit for coupling the rotor or shaft to an engine or other power source of the lawnmower for receiving power for rotation wherein the trimming lines rotate at a rotational speed of between 5,500-7,000 rpm, with about 6,000 to 6,500 rpms being preferred for cutting grass, weeds and other overgrown areas.

In yet another embodiment, a lawnmower capable of simultaneously mowing and trimming weeds and other overgrown areas is disclosed. The lawnmower includes a deck having a string or blade trimmer extension device stored or mounted therein. An internal combustion engine is mounted to or near the deck, a mulching blade for mowing lawn, a control handle for selectively extending the trimmer extension accessory from the deck and rotating the rotor of the trimmer head. A control button for changing the height and/or angle of the trimmer head or the position of the extension device for cutting weeds or other overgrown areas. The extension device receives power from the internal combustion engine or other power source of the lawnmower and the control handle also is selectively used for retracting or extending the trimmer extension device into or out of the deck.

In yet another embodiment, a method of simultaneously mowing a lawn or garden and trimming weeds, overgrown areas and small plants is described. The method includes the steps of providing a lawnmower having a manufactured or retrofitted string or blade trimmer extension attached to or mounted on the lawnmower deck. Then, mowing the lawn using a blade of the mower and mounted under the mower deck; extending the trimmer by using a control handle positioned on the lawnmower and near the handle of a push mower or steering wheel of the riding mower. The trimmer extends outwardly from an edge of the deck. The trimmer extension may extend out from the side edges, front or rear edges of the mowing deck depending on the preference of the operator. If the trimmer extension is mounted on the rear of the mower deck, it can be used to cut grass that is missed by the mower blade. The head of the trimmer rotates, and is operated using a control button positioned on the lawnmower in a place accessible by the operator. A flexible monofilament string or flexible blades for cutting grass, weeds and small plants are provided; and controlling, by using the control button, the speed, extent of extension and angle of trimming lines or blades to accommodate various trimming requirements. A gauge may be provided to show the amount string or blades that are left in the header.

In yet another embodiment, a lawnmower for providing simultaneous mowing and string or blade trimming capabilities is disclosed. The lawnmower includes a mower deck having a string or blade trimmer extension device integrated or retrofitted therein. An electric motor or other power source mounted to the deck for driving the trimmer accessory. A mulching blade or standard blade for mowing lawn. A control handle for selectively extending the string or blade trimmer extension device from the deck for trimming. A control button for selectively rotating a rotor or central shaft of a trimmer head of the extension device for trimming such that the extension device receives power from the electric motor or other power source of the lawnmower. The control button is also used for changing rotational speed of the trimming lines or blades.

In yet another embodiment, the blade of the lawnmower and the trimming lines or blades of the extension accessory are simultaneously operated. In yet another embodiment, the lawnmower is a riding or push lawnmower.

In yet another embodiment, a multifunctional lawnmower attachment featuring an integrated string or blade trimmer is disclosed. The lawnmower attachment is configured to be attached to a deck of a riding or push lawnmower and selectively extends outwardly from the deck and operating a control handle of the lawnmower. The trimmer is selectively activated while using the mower to trim weeds and other debris while simultaneously mowing the lawn, garden or other areas.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the string or blade trimmer extension device of the present invention in accordance with the disclosed architecture;

FIG. 2 illustrates an exploded view of one potential embodiment of the trimming header of the extension accessory of the present invention in accordance with the disclosed architecture;

FIG. 3 illustrates a perspective view of a lawnmower equipped with one potential embodiment of the string or blade trimmer extension device of the present invention in accordance with the disclosed architecture;

FIG. 4 illustrates a perspective view of a push lawnmower equipped with one potential embodiment of the string or blade trimmer extension accessory of the present invention in accordance with the disclosed architecture; and

FIG. 5 illustrates a perspective view showing the mechanism of extension and retraction of one potential embodiment of the string or blade trimmer extension attachment of the present invention in accordance with the disclosed architecture; and

FIG. 6 is a flow diagram showing a method of operation of one potential embodiment of the trimming accessory and lawnmower combination of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a lawnmower attachment that has an integrated string or blade trimmer. There is also a long-felt need in the art for a string or blade trimmer attachment that can be connected to a riding or push lawnmower. Additionally, there is a long-felt need in the art for an improved string or blade trimmer that does not require a user to carry and handle the trimmer during use. Moreover, there is a long-felt need in the art for a lawnmower that can perform mowing and trimming simultaneously, or substantially simultaneously. The lawnmower can be operated with just the trimmer running and not the blade of the mower so that the mower can be used as a trimmer. Further, there is a long-felt need in the art for a string or blade trimmer that can be integrated or removably attached to a lawnmower. Furthermore, there is a long-felt need in the art for a string or blade trimmer extension or accessory that reduces the time and effort of an individual to perform trimming. Finally, there is a long-felt need in the art for an improved lawn and garden care tool that offers a way to simultaneously mow a lawn and trim weeds without having to use an independent trimmer.

The present invention, in one exemplary embodiment, is a novel lawnmower providing simultaneous mowing and weed trimming capabilities. The lawnmower can be a push lawnmower or a riding lawnmower and includes a mower deck having a trimmer extension accessory integrated or retrofitted therein or mounted thereon. An engine mounted to the deck, a mulching blade or standard blade for mowing lawn, a control handle for selectively extending the trimmer extension device outward from the deck for trimming. A control button is used for selectively rotating the rotor or central axis of a trimmer head of the extension device for trimming. The extension device receives power from the electric motor or other power source of the lawnmower. The control button is also used for changing rotational speed of the trimming lines or blades.

In a further embodiment, the present invention relates to a combination lawnmower and trimmer accessory which includes a mower having a frame and mower deck and a control panel and a trimmer accessory connected to one of the frame or mower deck. The trimmer accessory is activated by controls on the control panel.

In a yet further embodiment, a trimmer accessory is provided, which may be retrofit to a frame or mowing deck of a lawnmower. The trimmer has a supply of string or flexible blades connected to head which provides rotational movement creating a cutting activity. The head is adjustable to select different cutting heights and may also allow for different amounts of string or the blades to be extended.

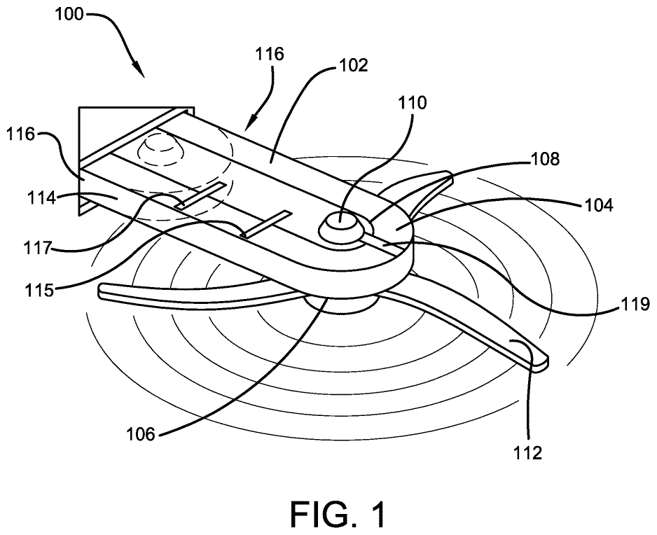

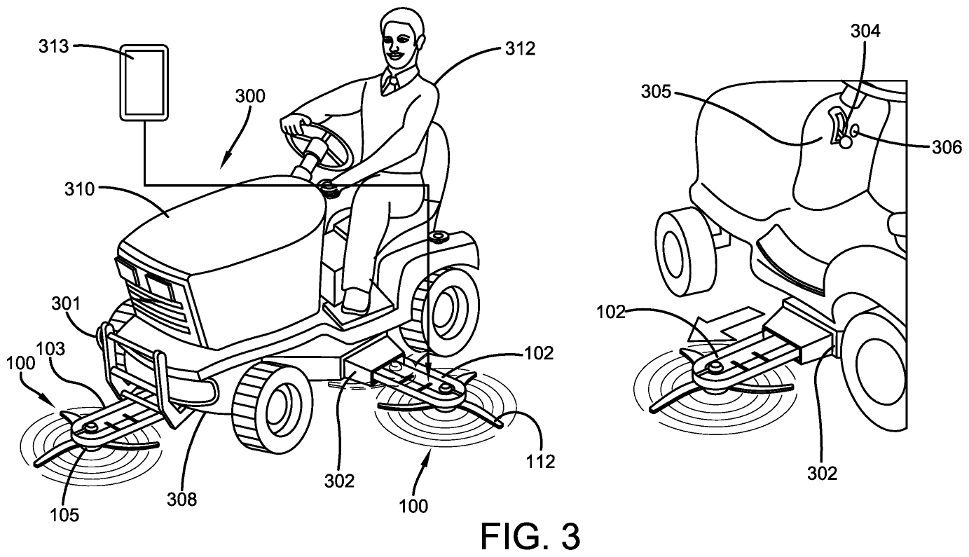

Referring initially to the drawings, FIG. 1 illustrates a perspective view of one potential embodiment of the string or blade trimmer extension device 100 of the present invention in accordance with the disclosed specification. The device 100 is designed to be integrated or retrofitted to the deck of a riding or push lawnmower. Further, the device 100 is selectively extendable and operable using a control bar disposed on the lawnmower device as illustrated in FIGS. 3 & 4.

More specifically, the attachment device 100 has a longitudinal track 102 that is configured to be extendable, retractable and positionable at different positions along the length of the track 102. The track 102 is positioned and fastened inside the deck of lawnmower and can be selectively retracted or extended from the deck. At the far end 104 of the track 102, a trimmer head 106 is removably fastened for trimming weeds, small plants and other overgrown areas and the trimmer head 106 is fastened to an opening 108 of the track 102 using a mechanical fastener 110 or may be placed in other slots 115 and 117 to adjust the position of the trimmer head. The head can be moved from a first position within the mower deck, to a second position and third position, which are along the length of the track, or to the fourth position or end of the track. The trimmer head 106 is coupled to the power supply of the lawnmower that provides power to rotor of the head 106. The trimmer head 106 may include a gauge 119 to show the amount of string remaining in the head or length of the blades extending outwardly from the central axis of the trimmer head 106.

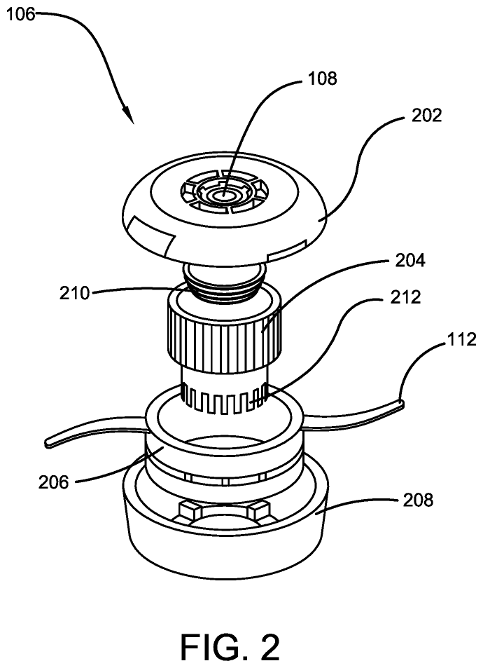

The trimmer header 106 has nylon or plastic trim lines or blades 112 that may be rolled on a spool or extended from a head (shown in FIG. 2) in a preferred embodiment. Alternatively, separate trim lines or blades 112 can also be attached to the trimmer head 106 for cutting down and trimming weeds, grass and overgrown areas. The trim lines 112 are rotated when the trimmer head 106 receives power from the lawnmower to which the attachment 100 is attached.

The track 102 has channels 114 along the side surfaces 116 that allow the attachment device 100 to easily extend or retract in the deck of a lawnmower. It should be appreciated that the track length and width can be designed based on lawnmower design and size.

FIG. 2 illustrates an exploded view of the trimming header 106 of the extension device 100 of the present invention in accordance with the disclosed specification. The trimming header 106 is used for cutting and trimming weeds, small plants, and debris. More specifically, a stator 202 is connected to the track (as shown in FIG.1) through the opening 108 or slots 115 and 117. The stator 202 maintains a secure connection with the track and also provides a connection to the rotor 204 with the engine or power source of the lawnmower to which the header 106 is attached. The stator 202 and the rotor 204 are connected to each other through a rotating connector 210. The trimmer head 106 may be used to dispense different amounts of string or length of the blades depending on the requirements of the cutting jobs. The head may advance the string or blades in increments of one inch up to a maximum amount of 8 inches. When the string or blades are consumed or break as part of the cutting activity, the head will advance the string or blade by a control 306 on the control panel 305.

The rotor 204 is configured to rotate between 5500-7000 rpm with about 6000 to 6500 rpms being preferred and produces an extremely low noise. The rotor 204 can also rotate in opposite direction using control button (shown in FIG. 3) for easy removal of trimming lines or blades 112 when stuck in the spool 206. The spool 206 is attached to the rotor 204 that allows the connected trimming lines or blades 112 to rotate for cutting and trimming grass, plants and weeds. A cover 208 protects the spool 206 and the trimming lines or blades 112 from physical damage due to stone, debris and ground.

Height of the connector 210 can be adjusted using the control button of the lawnmower thereby allowing the user to adjust the height of the trimming lines 112. The height adjustment ranges from 1 inch to about 12 inches with about 3 to 8 inches being preferred. Further, the gear system 212 is used for controlling and adjusting the rotational speed of the rotor 204.

FIG. 3 illustrates a perspective view of a lawnmower 300 having a frame 301 equipped with the trimmer extension device 100 in accordance with the disclosed specification. As illustrated, the lawnmower 300 is a conventional lawnmower having one or more blades 308 for mowing a lawn or garden. The deck 302 of the lawnmower 300 houses the extension device 100 used for trimming strings and cutting weeds and small plants. The accessory 100 is also shown extending out the front edge of the mowing deck having the track 103 and head 105. The deck 302 has a mounting bracket (not shown) that allows the channels of the track 102 to easily move linearly for extension and retraction of the device 100. The lawnmower 300 has an engine or other power source 310 that can be mounted on the deck 302. The engine 310 can be an internal combustion engine or an electric engine and is used for providing power to the extension device 100 for rotating the rotor and in turn rotating the trimming lines or blades as described in FIG.2.

A control handle 304 is disposed on the control panel 305 lawnmower 300 and is used for selectively extending or retracting the trimmer attachment 100 from the deck 302. The control handle 304 pushes the track 102 outward from the deck 302 and can be stopped at any desired extension as per preferences of a user 312 using slots 115, 117 as shown in FIG. 1. The track 102 is extended or retracted along the channels 114 that allow easy linear movement from and into the deck 302. When the device 100 is extended, the trimming lines or blades 112 start rotating to cut strings, weed, small plants and other overgrown areas.

A control button 306 is disposed on the control panel 305 of the lawnmower 300 is connected to the attachment 100 and is used for adjusting height and length or extension of the trimmer head of the attachment 100. More specifically, the control button 306 extends or retracts the connector 210 as described in FIG.2 to adjust the height of the blades 112. Once use of the trimmer attachment 100 is complete, rotation of the blades or string 112 is stopped using the control button 306 and the control handle 304 is pulled for retracting the track 102 back into the deck 302.

It should be noted that rotation of the blades or string 112 is powered by the engine or power source 310 and the attachment 100 is selectively activated using the control handle 304 and the control button 306 while simultaneously using the cutting blades 308 for mowing the garden or lawn. Accordingly, the lawnmower 300 saves the time of the user 312 by performing mowing and trimming simultaneously, substantially simultaneously or sequentially and eliminates the need for carrying a separate tool for trimming weeds and overgrown areas.

The track 102 can be extended from one to three feet outward from the deck 302 thereby allowing easy operation near the fences and on uneven surfaces. The head can be withdrawn back into the deck to avoid being sheared off when the mower gets too close to a hard or rigid object such as a curb, wall or the like. The control button 306 can be used to start the rotating of the blades 112 in the opposite direction and also for changing the angle and rotation speed (using the gear system) of the trimmer head as well as extending the string or blades as they are consumed during the cutting action. In a further embodiment, the trimmer accessory can be operated by a smartphone 313 which has a previously downloaded application and is connected to the trimmer accessory. The use of a smartphone may occur where the trimmer accessory is added as an after-market accessory.

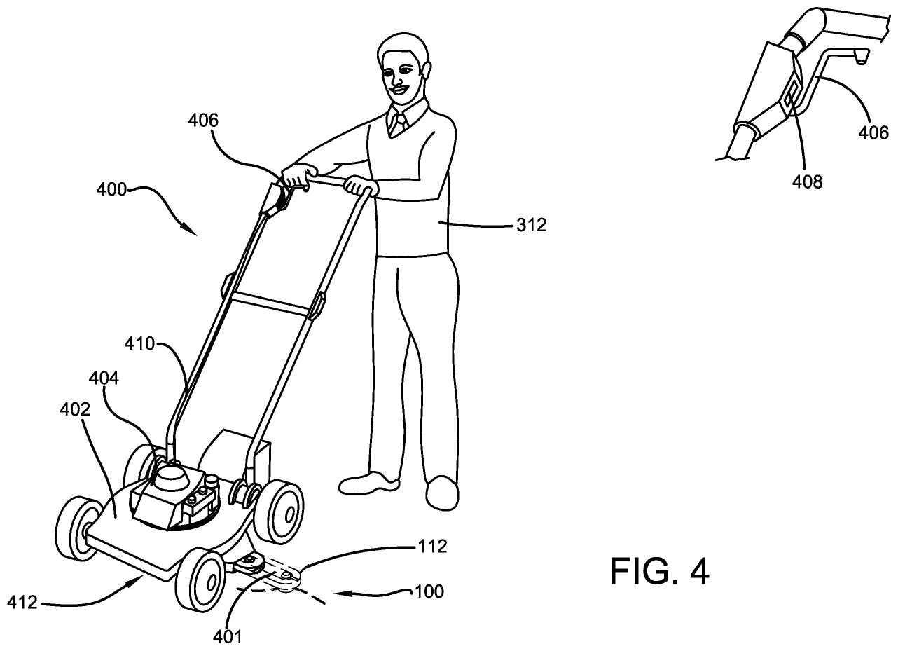

FIG. 4 illustrates a perspective view of a push lawnmower 400 equipped with the string or blade trimmer extension accessory 100 in accordance with the disclosed structure. In the present embodiment, the push lawnmower 400 is designed to perform mowing and trimming simultaneously, substantially simultaneously or sequentially thereby eliminating the need for the user 312 to use a separate string or blade trimmer device. The lawnmower 400 has a deck or frame 402 for housing the string or blade trimmer extension attachment 100. An engine 404 is mounted to the deck 402 and is used for providing power for operation of the cutting blades 412 and the blades 112.

A control handle 406 and a control button 408 are connected to the engine or power source 404 and the extension device 100 through a connecting wire 410 for controlling and operating the accessory 100. The control handle 406 is used for selectively extending, positioning or retracting the weed whacker attachment 100 from the deck 402. The control button 408 is used for adjusting height of the trimmer head of the attachment 100. The control button 408 is also used for rotating the blades 112 in the opposite direction and also for changing the angle of rotation of the blades 112 and for advancing additional string or blade length.

It should be noted that in one embodiment of the attachment device 100, an inbuilt motor is present. The motor is supplied power from the engine of the lawnmower and the motor is used for rotating the rotor and the spool of the device 100.

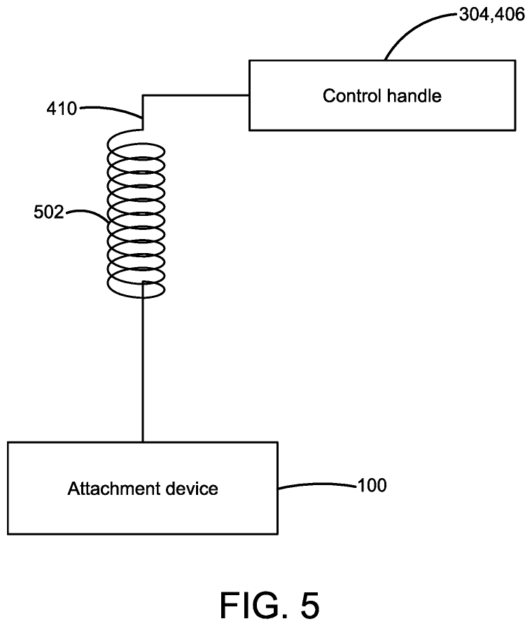

FIG. 5 illustrates a perspective view showing the mechanism of extension and retraction of the string or blade trimmer extension attachment of the present invention in accordance with the disclosed specification. The attachment 100 is designed to extended outward from the deck of a lawnmower when a control handle 406 (or 304) is pushed. The control handle can be used to position the head at different positions 401 along the length of the track. When the control handle 406 is pushed, the connecting wire 410, connecting the control handle and a spring mechanism 502, pushes the spring 502, thereby pushing the attachment device 100 outward from the deck of the lawnmower. The spring 502 is extended in a controlled manner and extension is stopped when the handle 406 is not pushed.

For pulling the attachment device inside the deck, the control handle 406 is pulled and the spring 502 is contracted, thereby pulling the attachment 100 inside the deck.

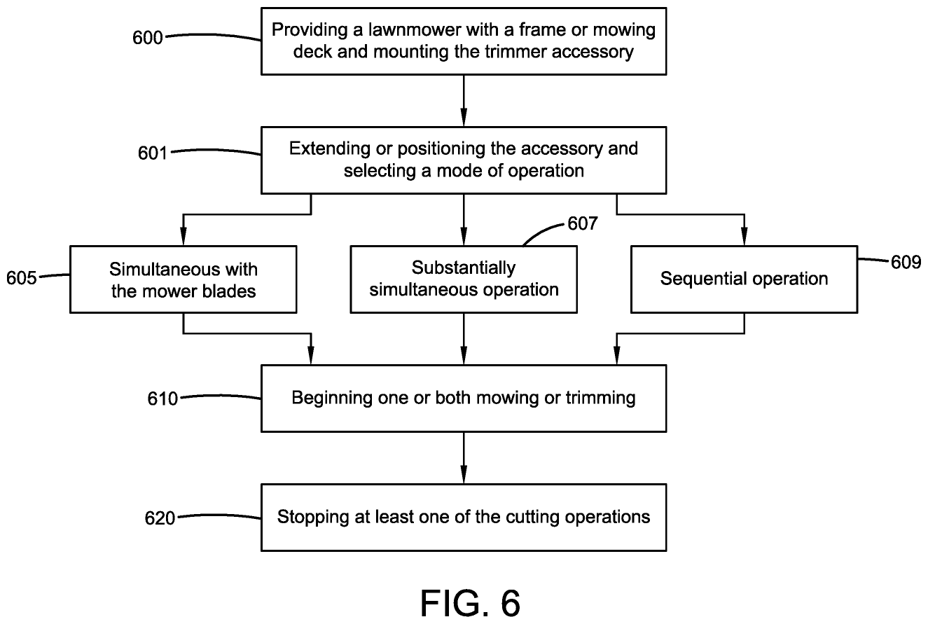

FIG. 6 is a flow diagram showing an exemplary method for using the cutting or trimmer accessory for a lawnmower and consists of initially providing a lawnmower with a frame or a mower deck having a trimmer attached to the frame or mower deck at step 600. Then extending or positioning the trimmer accessory and selecting an operation of the trimmer accessory at step 601. Next, selecting a mode of operation of the trimmer at steps 605, 607 or 609. The mode of operation includes one of simultaneous operation 605, substantially simultaneous operation 607 or sequential operation 609. Then beginning one or both the mowing and trimming operation at step 610 and stopping at least one of the cutting operations at step 610.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “weed whacker attachment”, “attachment”, “weed whacker or string trimmer extension attachment”, and “extension device” are interchangeable and refer to the weed whacker or string trimmer extension attachment device 100 of the present invention.

Notwithstanding the forgoing, the weed whacker or string trimmer extension attachment device 100 of the present invention can be of any suitable size and configuration as is known in the art without affecting the overall concept of the invention, provided that it accomplishes the above-stated objectives. One of ordinary skill in the art will appreciate that the weed whacker or string trimmer extension attachment device 100 as shown in the FIGS. are for illustrative purposes only, and that many other sizes and shapes of the weed whacker or string trimmer extension attachment device 100 are well within the scope of the present disclosure. Although the dimensions of the weed whacker or string trimmer extension attachment device 100 are important design parameters for user convenience, the weed whacker or string trimmer extension attachment device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trimmer accessory for a lawnmower, the trimmer accessory comprising:
a track that is sized and configured for mounting to one of a frame or a mower deck of the lawnmower;
a trimmer head movably connected to the track, wherein the trimmer head comprises a supply of string or at least one flexible blade; and
a power source connected to the trimmer head for providing a force to rotate the trimmer head to allow the supply of string or the at least one flexible blade to trim a vegetation.

2. The trimmer accessory as recited in claim 1, wherein the trimmer head rotates at a speed of between 5,500 and 7,000 RPMs.

3. The trimmer accessory as recited in claim 2, wherein the trimmer head rotates at a speed of between 6,000 and 6,500 RPMs.

4. The trimmer accessory as recited in claim 1, wherein the trimmer head is adjustable in height between 1 and 12 inches.

5. The trimmer accessory as recited in claim 4, wherein the trimmer head is adjustable in height between 3 and 8 inches.

6. The trimmer accessory as recited in claim 1, wherein the track has up to four positions to position the trimmer head there along.

7. The trimmer accessory as recited in claim 6, wherein a first position of the track has the trimmer head in the mower deck or frame, a second position and a third position of the track has the trimmer head disposed along a length of the track, and a fourth position of the track has the trimmer head at an end of the track.

8. The trimmer accessory as recited in claim 1, wherein trimmer head is connected to a control mounted to the lawnmower.

9. The trimmer accessory as recited in claim 1, wherein the trimmer accessory is connected to the mower deck of the lawnmower.

10. The trimmer accessory as recited in claim 1, wherein the trimmer accessory may be operated in one of a simultaneously, a substantially simultaneously or a sequentially with a cutting blade of the lawnmower.

11. A combination lawnmower and trimmer attachment comprising:
a lawnmower comprising a mower deck, a frame, a cutting blade and a control; and
a trimmer attachment comprising a track that is attached to one of the mower deck or the frame and that is in communication with the control, wherein the trimmer attachment comprises a trimmer head having at least one of a supply of string or at least one blade for cutting, and further wherein the trimmer head is repositionable between a plurality of positions along a length of the track.

12. The combination lawnmower and trimmer attachment as recited in claim 11, wherein the lawnmower is a riding mower.

13. The combination lawnmower and trimmer attachment as recited in claim 11, wherein the lawnmower is a push mower.

14. The combination lawnmower and trimmer attachment as recited in claim 11, wherein the trimmer head rotates at as speed of between 5,500 and 7,000 RPMs.

15. The combination lawnmower and trimmer attachment as recited in claim 11, wherein the trimmer head is adjustable in height between about 1 inch to about 12 inches.

16. The combination lawnmower and trimmer attachment as recited in claim 11, wherein the trimmer head is capable of operating in at least one of a plurality of modes in relation to the cutting blade of the lawnmower: a simultaneous mode, a substantially simultaneous mode and a sequentially simultaneous mode.

17. The combination lawnmower and trimmer attachment as recited in claim 11, wherein the plurality of positions along the length of the track comprise a first position, a second position, a third position and a fourth position.

18. The combination lawnmower and trimmer attachment as recited in claim 11, wherein the control is mounted on one of a control panel of a riding mower or a handle of a push mower.

19. The combination lawnmower and trimmer attachment as recited in claim 11, wherein the trimmer attachment is spring activated.

20. A method of using a trimmer accessory with a lawnmower comprising the steps of:
providing the lawnmower having a frame or a mower deck;
mounting the trimmer accessory to one of the mower deck or the frame;
extending or positioning the trimmer accessory along a track;
selecting a mode of operation, wherein the mode of operation is a select one of a simultaneous mode, a substantially simultaneous mode or a sequential mode in relation to an operation of a mowing blade on the lawnmower;
beginning at least one of a mowing or a trimming operation; and
stopping the at least the one mowing or trimming operation.
